(19) United States
(12) Patent Application Publication
(10) Pub. No.: US 2018/0277890 A1
(43) Pub. Date: Sep. 27, 2018

(54) SOLID ELECTROLYTE FOR ALL-SOLID-STATE LITHIUM ION SECONDARY BATTERY, ALL-SOLID-STATE LITHIUM ION SECONDARY BATTERY USING THE SAME, AND METHOD FOR PRODUCING SOLID ELECTROLYTE FOR ALL-SOLID-STATE LITHIUM ION SECONDARY BATTERY

(71) Applicant: Hitachi Metals, Ltd., Tokyo (JP)

(72) Inventors: Itaru UEDA, Tokyo (JP); Toshiki KIDA, Tokyo (JP); Naoyuki OKAMOTO, Tokyo (JP); Hiroyuki ITO, Tokyo (JP)

(73) Assignee: Hitachi Metals, Ltd., Tokyo (JP)

(21) Appl. No.: 15/730,097

(22) Filed: Oct. 11, 2017

(30) Foreign Application Priority Data
Mar. 23, 2017 (JP) 2017-056836

(51) Int. Cl. H01M 10/0562; H01M 10/0525; H01M 4/131

(52) U.S. Cl. CPC H01M 10/0562; H01M 2004/028; H01M 4/131; H01M 10/0525

(57) ABSTRACT

A solid electrolyte for all-solid-state lithium-ion secondary batteries, which is a sintered body having Li-La-Zr garnet phases having a garnet-type crystal structure, which is Li₇La₃Zr₂O₁₂, or Li₇La₃Zr₂O₁₂, partially substituted by at least one element selected from the group consisting of Nb, Al and Ta, and Li₂₊ₓC₁₋ₓBₓO₃ (0<x<0.8) phases, is produced by mixing raw materials comprising Li-La-Zr garnet and Li₂₊ₓC₁₋ₓBₓO₃ (0<x<0.8), molding the mixed raw materials, and sintering the resultant green body.

### CROSS-REFERENCE TO RELATED APPLICATION

This application claims priority to Japanese Application Number 2017-056836, filed Mar. 23, 2017, the entire content of which is hereby incorporated by reference.

### FIELD OF THE INVENTION

The present invention relates to a solid electrolyte for all-solid-state lithium-ion secondary batteries with less abnormal phases having low ionic conductivity, and an all-solid-state lithium-ion secondary battery comprising it, and a method for producing a solid electrolyte for all-solid-state lithium-ion secondary batteries.

### BACKGROUND OF THE INVENTION

Lithium secondary batteries using fireproof or fire-retardant solid electrolytes have high heat resistance, thereby safely preventing the leak of an electrolyte solution and accompanying fire, etc. They also have high energy density.

Investigated as a method for producing a solid electrolyte is, for example, a method of sintering oxide having a garnet-type, cubic crystal structure, which is Li₇La₃Zr₂O₁₂ as an ionic conductor, or Li₇La₃Zr₂O₁₂ partially substituted by elements such as Nb, Al and Ta, etc., at a low temperature.

Patent References 1 to 10 disclose batteries each comprising a solid electrolyte together with a positive electrode and a negative electrode, at least one of the positive electrode, the negative electrode and the solid electrolyte comprising a Li—B—O compound, etc. Patent References 1 to 3 disclose the use of Li₂CO₃ as a sintering aid. Patent References 4 to 10 disclose methods using Li₃BO₃ as a sintering aid.

When Li₂CO₃ or Li₃BO₃ is used as a sintering aid for Li₇La₃Zr₂O₁₂ (LLZ) as described in Patent References 1 to 10, abnormal phases having low ionic conductivity are likely formed by sintering, making it difficult to obtain good battery characteristics stably.

### PRIOR ART REFERENCES

Patent Reference 1: JP 2010-202499 A

Patent Reference 2: JP 2010-272344 A

Patent Reference 3: JP 2011-070939 A

Patent Reference 4: JP 2015-041573 A

Patent Reference 5: JP 2015-185228 A

Patent Reference 6: JP 2015-204215 A

Patent Reference 7: WO 2012/176808 A

Patent Reference 8: WO 2015/079509 A

Patent Reference 9: WO 2015/151144 A

Patent Reference 10: JP 2013-037992 A

### SUMMARY OF THE INVENTION

An object of the present invention is to provide a solid electrolyte for all-solid-state lithium-ion secondary batteries with less abnormal phases having low ionic conductivity, an all-solid-state lithium-ion secondary battery using this solid electrolyte, and a method for producing this solid electrolyte for all-solid-state lithium-ion secondary batteries.

Thus, the solid electrolyte of the present invention for all-solid-state lithium-ion secondary batteries is a sintered body having Li-La-Zr garnet phases and Li₂₊ₓC₁₋ₓBₓO₃ (0<x<0.8) phases.

The range of x is preferably 0.1≤x≤0.6.

The solid electrolyte preferably exhibits an X-ray diffraction pattern having those of Li-La-Zr garnet and a Li₂CO₃ solid solution, the range of x being 0.2≤x≤0.4.

The Li-La-Zr garnet may be a compound having a garnet-type crystal structure, which is Li₇La₃Zr₂O₁₂, or Li₇La₃Zr₂O₁₂ partially substituted by at least one element selected from the group consisting of Nb, Al and Ta.

The all-solid-state lithium-ion secondary battery of the present invention comprises the above solid electrolyte, a positive electrode, and a negative electrode.

The positive electrode is preferably made of LiCoO₂ and Li₂₊ₓC₁₋ₓBₓO₃ (0<x<0.8).

The method of the present invention for producing a solid electrolyte for all-solid-state lithium-ion secondary batteries comprises the steps of mixing raw materials comprising Li-La-Zr garnet and Li₂₊ₓC₁₋ₓBₓO₃ (0<x<0.8); molding the mixed raw materials; and sintering the resultant green body.

Li₂₊ₓC₁₋ₓBₓO₃ (0<x<0.8) is preferably formed by mixing lithium carbonate with a boron compound at a predetermined ratio, and heat-treating the resultant mixture.

The boron compound is preferably boric acid or boron oxide.

The raw material comprising Li₂₊ₓC₁₋ₓBₓO₃ (0<x<0.8) preferably has diameters of less than 10 μm.

The raw material is preferably mixed with a solvent to prepare a slurry, which is formed into pluralities of sheets, and then laminated to obtain the green body.

### BRIEF DESCRIPTION OF THE DRAWINGS

FIG. 1 is a SEM image of the solid electrolyte of the present invention.

FIG. 2 is a flowchart showing the production steps of LLZ powder.

FIG. 3 is a flowchart showing the production steps of the solid electrolyte of the present invention.

FIG. 4 is a flowchart showing the production steps of LCBO powder.

FIG. 5 is a SEM photograph showing LCBO powder.

FIG. 6 is a graph showing the XRD data of LLZ powders in Examples 1-5 and Comparative Examples 1 and 2.

FIG. 7 is a graph showing the XRD data of LCBO powder at x=0.0, 0.2, 0.4, 0.6, 0.8, 0.9, and 1.0.

FIG. 8 is a SEM photograph showing a cross section of the sintered body of Example 4.

FIG. 9 is a La-mapping image of the sintered body of Example 4, which is obtained in the same field as in FIG. 8.

FIG. 10 is a C-mapping image of the sintered body of Example 4, which is obtained in the same field as in FIG. 8.

### DETAILED DESCRIPTION OF THE INVENTION

A solid electrolyte for all-solid-state lithium-ion secondary batteries according to the first embodiment of the present invention is a sintered body comprising Li-La-Zr garnet phases, and Li₂₊ₓC₁₋ₓBₓO₃ (0<x<0.8) phases. This sintered body is not limited to a dense sintered body, but may be a sintered body in which particles of the same or different types are partially bonded by sintering (subjected to necking). Hereinbelow, the Li-La-Zr garnet may be simply expressed by “LLZ,” and Li₂₊C₁₋ₓBₓO₃ may be simply expressed by “LCBO.” The Li-La-Zr garnet is a compound having a garnet-type crystal structure, which is, for example, Li₇La₃Zr₂O₁₂, or Li₇La₃Zr₂O₁₂ partially substituted by at least one element selected from the group consisting of Nb, Al and Ta. The substituting elements may be other elements such as Ni, Cu, Ba, Sr, Ca, etc.

Though LLZ has high ionic conductivity, the sintering of LLZ and LBO in contact with each other likely causes reaction in their interfaces, forming abnormal phases having low ionic conductivity (La₂Zr₂O₇, etc.), which increase resistance in interfaces of crystal grains, thereby providing batteries with poor characteristics. The inventors have found that Li₂₊ₓC₁₋ₓBₓO₃ (0<x<0.8) used in place of Li₂CO₃ or Li₃BO₃ in the sintering of LLZ generates a sintering aid having high ionic conductivity, while suppressing the formation of abnormal phases having low ionic conductivity (La₂Zr₂O₇). This appears to be due to the fact that abnormal phases are formed when Li decreases in LLZ in the sintered body, and that when Li₂₊ₓC₁₋ₓBₓO₃ (0<x<0.8) is used, less Li is removed from LLZ in the sintered body, resulting in LLZ suffering less decrease in Li than when Li₃BO₃ is used. Also, LCBO used acts as a sintering aid, enabling sintering at a temperature as low as 700° C. or lower.

When x is in a range of 0.1≤x≤0.6, a smaller amount of abnormal phases having low ionic conductivity are desirably formed. Decrease in the abnormal phases can be confirmed by a lower signal intensity of a diffraction angle assigned to the abnormal phases (La₂Zr₂O₇) having low ionic conductivity in an X-ray diffraction (XRD) pattern.

When x is in a more preferred range of 0.2≤x≤0.4, high-ionic-conductivity solid electrolyte consisting of LLZ and LCBO with substantially no abnormal phases having low ionic conductivity can be obtained.

Decrease in abnormal phases in LCBO in the above range x of B can be confirmed by decrease in signal intensity of a diffraction angle assigned to the abnormal phases (La₂Zr₂O₇) having low ionic conductivity in an XRD pattern. The existence of B (boron) and C (carbon) in the LCBO phases can be confirmed by EPMA measurement.

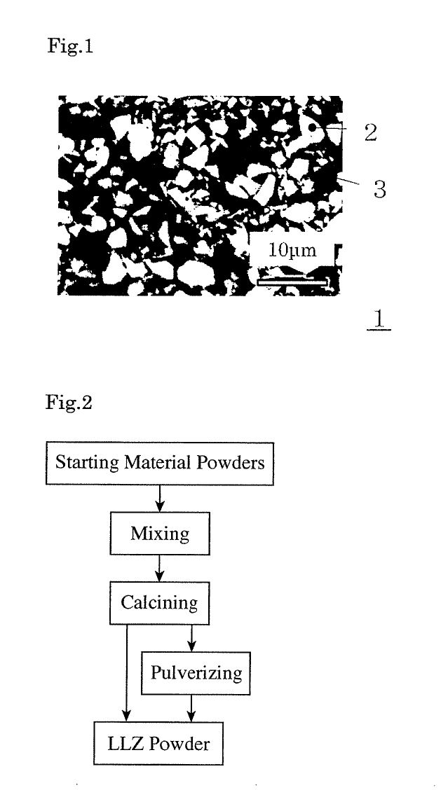

LLZ has high ionic conductivity. LCBO has ionic conductivity, and starts a solid-state reaction at a lower temperature than that of LLZ, thereby functioning as a sintering aid in the production of the solid electrolyte. Accordingly, their combination at a proper ratio can provide high ionic conductivity and low-temperature sinterability. FIG. 1 is a SEM image showing a cross section of the solid electrolyte 1 of the present invention for all-solid-state lithium-ion secondary batteries. The solid electrolyte 1 of the present invention is a densely sintered polycrystalline substance, with boundaries of LLZ crystal grain phases 2 filled with LCBO phases 3. Particularly, solid-state reacted boundaries between the LLZ crystal grain phases 2 and the LCBO phases 3 are crystal grain boundaries having high ionic conductivity.

In the present invention, the above solid electrolyte is sintered with a positive electrode material and a negative electrode material both containing LCBO as a sintering aid, etc. Because LCBO contained in these phases is solid-state reacted, an all-solid-state lithium-ion secondary battery can be obtained by a single sintering step. Namely, a single sintering step of the solid electrolyte with a positive electrode material and a negative electrode material can provide an all-solid-state lithium-ion secondary battery having high conduction of electrons and ions, etc. as battery characteristics, thereby providing not only higher characteristics and lower production cost, but also sintering energy decreased by the reduced number of sintering steps, resulting in a lower environmental load.

Raw material powders comprising LLZ and LCBO, which are used for the production of the solid electrolyte of the present invention for all-solid-state lithium-ion secondary batteries, will be explained in detail below.

Though commercially available LLZ powder may be used, LLZ powder is preferably formed, for example, according to the flowchart of FIG. 2. Well-known raw material powders of LLZ may be used. To add Nb, Ta, Ba, Sr, Ca, etc., Nb₂O₅, Ta₂O₅, BaCO₃, SrCO₃, CaCO₃, etc. may be used. For example, ZrO₂, Li₂CO₃, Al₂O₃ and La(OH)₃ are mixed at predetermined proportions, and calcined at a temperature ranging from 700° C. to 1000° C. in the air to obtain LLZ powder. In the calcining step, the keeping of a constant temperature may be intervened by disintegration, etc. To obtain LLZ powder, disintegration may be conducted in the course of calcining, or an apparatus such as a rotary kiln may be used, or a continuous furnace, etc. may be used for efficient mass calcination. The resultant LLZ powder may be pulverized if necessary.

LCBO powder may be formed according to the flowchart of FIG. 4. For example, lithium carbonate powder and boron compound powder, raw materials for LCBO, are mixed at a predetermined ratio, and calcined at a temperature ranging from 500° C. to 800° C. in the air to obtain LCBO powder. The ratio of lithium carbonate to the boron compound may be determined according to the amounts of a Li element and a B element in the molecular formula of Li₂₊ₓC₁₋ₓBₓO₃. For example, when boric acid (H₃BO₃) is used as the boron compound, lithium carbonate is [(2+x)/2] mol, and boric acid is (x) mol. When boron oxide (B₂O₃) is used as the boron compound, lithium carbonate is [(2+x)/2] mol, and boron oxide is (x/2) mol. To obtain LCBO powder, the calcination may be intervened by disintegration, or an apparatus such as a rotary kiln may be used, or a continuous furnace, etc. may be used for efficient mass calcination. The resultant LCBO powder may be pulverized if necessary.

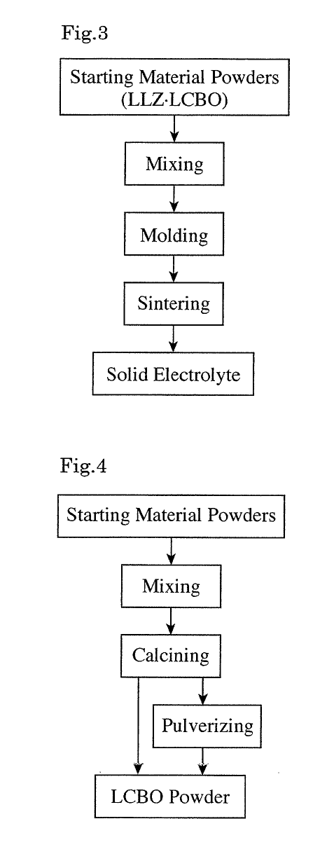

An example of the production methods of the solid electrolyte of the present invention for all-solid-state lithium-ion secondary batteries will be explained below according to the flowchart of FIG. 3.

The above LLZ powder and the LCBO powder are mixed at a predetermined ratio to obtain a mixture powder. The ratio of the LLZ powder to the LCBO powder may be determined to achieve sufficient densification by sintering. For example, the LLZ powder and the LCBO powder are preferably mixed, such that a volume ratio of LLZ phases to the entire volume of the solid electrolyte is 30-60%, resulting in a dense sintered body having high ionic conductivity. When only the LLZ powder is used, the densifying temperature is about 1200° C., but the mixing of the LLZ powder with the LCBO powder lowers the densifying temperature to about 650-900° C. However, too high a mixing ratio of the LCBO powder reduces the volume ratio of the LLZ powder having high ionic conductivity, making it difficult to obtain good characteristics. Thus, the mixing ratio of powders should be properly selected.

It is preferable to use a mixing method ensuring sufficient densification in sintering and providing the uniform dispersion of raw material powders, and a mixing apparatus such as a ball mill, a jet mill, a planetary ball mill, SPARTAN-RYUZER, etc. can be used.

It is preferable to use a mixing method capable of providing a mixture desirable for subsequent molding and sintering. For example, wet ball milling can preferably conduct mixing and pulverization simultaneously to adjust the diameters of the raw material powders, with uniform dispersion. When sheet molding is conducted in the next molding step, a binder, a plasticizer, etc. may be added in the wet ball milling to adjust the viscosity, etc. of slurry. When paste printing, etc. are conducted as the next molding step, a solvent for making coating easy may be used in the wet ball milling. When pressing is conducted as the molding step, a slurry mixed by wet ball milling may be dried.

When mixing and pulverization are conducted with a liquid solvent as a medium, the use of toluene, etc. rather than water and ethanol as a solvent can preferably suppress the formation of abnormal phases during pulverization. Because the powders are easily reactable with moisture, etc. in the air, degassing may be conducted before pulverization. The mixture powder is obtained through the above mixing step.

The mixture powder is molded. In the molding step, the mixture powder is densely packed to achieve high density in a subsequent sintering step. For molding, sheet molding using a doctor blade, a combination of paste printing and pressing, die-pressing, etc. can be conducted. For example, the sheet molding using a doctor blade can be conducted by putting a mixture powder slurry on a carrier film, forming it to a sheet with a constant thickness by a doctor blade, and evaporating off the solvent from the slurry to obtain a sheet-shaped green body. This sheet-shaped green body is easily laminated with a sheet-shaped positive electrode material green body and a sheet-shaped negative electrode material green body, so that in a subsequent sintering step, the solid electrolyte, the positive electrode material and the negative electrode material can be sintered by one operation, resulting in a reduced number of production steps of the all-solid-state lithium-ion secondary battery. Further, by laminating and sintering large pairs of positive electrode materials, solid electrolytes and negative electrode materials, an all-solid-state lithium-ion secondary battery having high energy density can be obtained. The green body is obtained by this step.

The green body is sintered. In the sintering step, raw material powders in the green body are reacted and highly densified for ionic conduction. Ideally, the sintered body does not have voids, with density close to a composition-based theoretical density. The reaction temperature is preferably 900° C. or lower to obtain the crystal structure of LLZ having high ionic conduction, and 650° C. or higher to accelerate sintering densification. The reaction temperature is particularly in a range of 700-750° C. The sintering time is preferably 1 hour or more to proceed sintering, and 10 hours or less for a short step time. The sintering time of 2-5 hours is more preferable to achieve enough sintering and a short step time. The sintering atmosphere may use oxygen, etc., and the air is particularly preferable for degreasing and cost. Before this step, the sublimation (degreasing) of a binder may be conducted. The solid electrolyte for all-solid-state lithium-ion secondary batteries is obtained through the above steps.

When the solid electrolyte green body is laminated with a sheet-shaped positive electrode material green body and a sheet-shaped negative electrode material green body in the molding step, an integral sintered body of the positive electrode, the solid electrolyte and the negative electrode can be obtained through the sintering step. Because the sintered body is solid, of course, its combination with a current collector, electrodes, a battery cover, etc. provides an all-solid-state lithium-ion secondary battery. It is preferable to use a green body of a mixture of a positive electrode active material and Li₂₊ₓC₁₋ₓBₓO₃ (0<x<0.8) for a positive electrode, because it is densified at the same sintering temperature as that of the solid electrolyte. The use of LiCoO₂ as the positive electrode active material is preferable, because less abnormal phases are formed by sintering with Li₂₊ₓC₁₋ₓBₓO₃ (0<x<0.8).

The present invention will be explained in more detail by Examples and Comparative Examples below, without intention of restriction.

### EXAMPLES 1-5

### Production of LLZ

LLZ was produced according to the flowchart (FIG. 2). To obtain Li₇La₃Zr₂O₁₂ as calcined LLZ powder, Li₂CO₃, La(OH)₃ and ZrO₂ were mixed as raw materials at proportions of Li, La and Zr of 7/3/2. A small amount of Al₂O₃ was added at a composition ratio Li/Al of 7/0.3. These materials were mixed and calcined to obtain LLZ. Incidentally, in place of Al₂O₃, a compound of Nb or Ta may be used. Nb and Ta also occupy Zr sites, exhibiting the same effect of stabilizing high-ionic-conductivity phases as that of Al.

### Production of LCBO

LCBO was produced according to the flowchart (FIG. 4) as described above. Lithium carbonate (Li₂CO₃) available from Hayashi Pure Chemical Ind. Ltd. was mixed with boric acid (H₃BO₃) available from Kojundo Chemical Laboratory Co., Ltd. at the composition ratios of Examples 1-5 shown in Table 1, in a mortar. During calcination at 600° C. for 20 hours in an alumina crucible, the resultant mixture powder was kept at 600° C. for 10 hours, disintegrated in a mortar, caused to pass through a sieve having an opening diameter of 500 μm, and then kept at 600° C. for 10 hours again. The thus calcined powder was disintegrated in a mortar, and caused to pass through a sieve having an opening diameter of 500 μm to obtain the LCBO powder.

XRD analysis confirmed that this powder had a crystal structure of LCBO, whose diffraction pattern is shifted from that of Li₂CO₃.

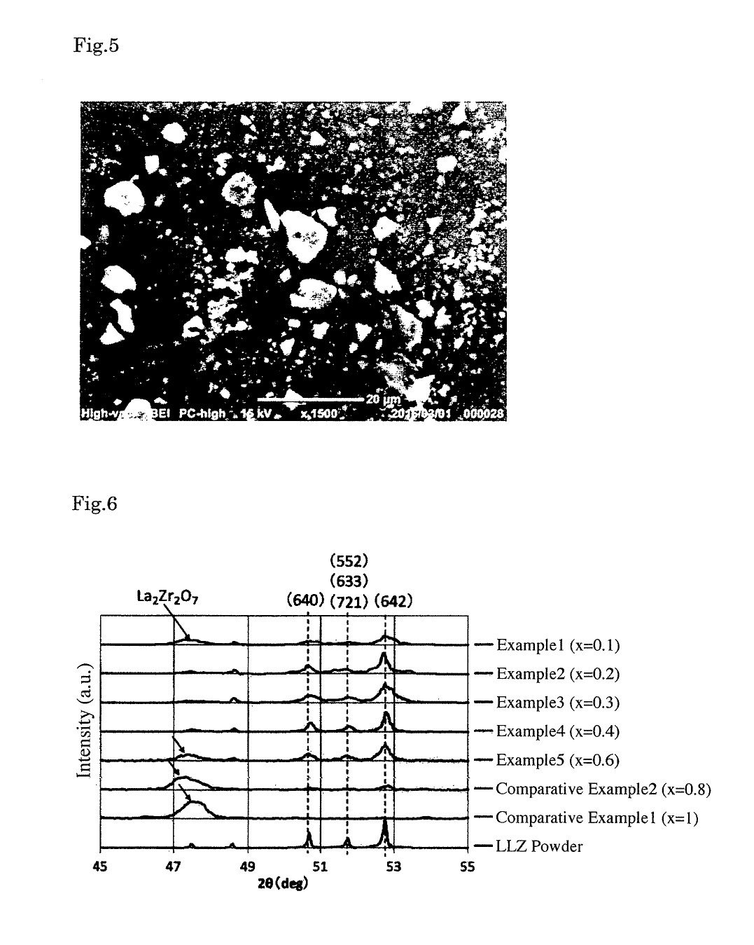

This LCBO powder was pulverized in toluene as a solvent by a ball mill with zirconia balls, and the resultant slurry was dried, and disintegrated to obtain fine LCBO particles with adjusted diameters in a mortar. The scanning electron microscopic (SEM) image of the fine LCBO particles is shown in FIG. 5. To enable the formation of thin sheets for a laminate by a doctor blade method in a subsequent molding step, the diameters of the fine LCBO particles are preferably smaller than a blade gap. For example, the shorter diameters of fine LCBO particles are preferably adjusted to less than 10 μm in a SEM image. For example, in FIG. 5, the shorter diameters are at most about 5 μm. Thus, particles are not dragged by a blade in sheet molding, avoiding streaks from being formed in the resultant sheets. Why shorter diameters are selected as particle diameters is that because the directions of powder particles are changed by a blade in a doctor blade method, not long diameters but shorter diameters determine whether or not the particles can pass through a blade gap. For example, with a gap of 10 μm between the blade and a film, the shorter diameters of less than 10 μm enable the particles to pass through the gap. When pulverization is conducted in water or ethanol as a solvent, abnormal phases are formed after pulverization, toluene having low affinity for water, etc. are desirably used as a solvent. Thus, fine LCBO particles were obtained.

### Production of Solid Electrolyte Laminate

The production of a solid electrolyte laminate by sheet molding will be exemplified below. 21 g of LLZ powder, 9 g of LCBO powder, and 40 g of a polyvinyl butyral solution (solvent: toluene) containing DOP (dioctyl phthalate) as a plasticizer were weighed, and mixed in a ball mill with zirconia balls to prepare a mixture powder slurry. To provide the resultant slurry with viscosity suitable for sheet molding by a doctor blade method, the solvent was evaporated while stirring to adjust the viscosity. After adjusted to the desired viscosity, green sheets were formed by the doctor blade method. Each green sheet was as thick as 70 μm. 20 pieces punched out of the green sheet by a punching jig having a diameter of 14 mm were laminated and pressed while heating to produce a laminate. After degreasing, the laminate was kept at 700° C. for 1 hour in the air to obtain a sintered body. The sintered body was made flat by grinding both surfaces with sandpaper, and formed phases were observed by XRD. A sample having electrodes formed on both surfaces of the sintered body was produced, and its ionic conductivity was measured by an impedance analyzer (IM3570 available from HIOKI) according to an AC impedance method, at a frequency of 4 Hz to 5 MHz and an amplitude of 1.0 V.

### Production of Samples by Solid Electrolyte Paste Printing

An example of methods for producing thinner layers for a solid electrolyte laminate by paste printing will be explained below. 0.70 g of LLZ powder, and 0.30 g of LCBO powder were weighed and mixed, and the resultant mixture powder was mixed with 1.0 g of a 5-%-by-mass ethyl cellulose solution (solvent: butyl carbitol acetate), to prepare each solid electrolyte paste.

Each paste was applied to an Au foil, etc. punched out to a predetermined size by a screen-printing method, to form each coating layer. To obtain a desired coating thickness, printing was conducted plural times if necessary, and each coating was adhered to the underlying foil by pressing to produce each sample. After degreasing, each sample was kept at 700° C. for 1 hour in the air to obtain each sintered body.

Formed phases in each sintered body were observed by XRD. An electrode was formed on a surface of the sintered body, on which the Au foil was not adhered. Thereafter, the ionic conductivity of the sintered body was evaluated by an AC impedance method using an impedance analyzer (IM3570 available from Hioki). XRD measurement was conducted using X'pert PRO available from PANalytical (registered trademark), with a Cu target, and tube voltage of 45 kV. After data treatment of removing background, smoothing and removing CuKα2, the XRD data were analyzed. Examples 1-5 shown in Table 1 were produced by sheet molding, laminating and sintering.

### Comparative Example 1

The same lithium carbonate (Li₂CO₃) and boric acid (H₃BO₃) as in Examples were formulated to a composition ratio of Comparative Example 1 shown in Table 1, and mixed in a mortar. During calcination at 600° C. for 20 hours in an alumina crucible, the mixture powder was kept at 600° C. for 10 hours, disintegrated in a mortar, caused to pass through a sieve having an opening diameter of 500 μm, and kept at 600° C. for 10 hours again. The resultant calcined powder was disintegrated in a mortar, and caused to pass through a sieve having an opening diameter of 500 μm to form Li₃BO₃ free of C.

XRD analysis confirmed that this powder had a crystal structure of Li₃BO₃. This LBO powder was pulverized in toluene as a solvent in a ball mill with zirconia balls. The resultant slurry was dried, disintegrated in a mortar, and caused to pass through a sieve having an opening diameter of 500 μm to obtain fine Li₃BO₃ particles. Using the fine Li₃BO₃ particles, a sample was produced by the same method as for the laminates of Examples above, and the resultant sample was evaluated in the same manner as in Examples above.

### Comparative Example 2

The same lithium carbonate (Li₂CO₃) and boric acid (H₃BO₃) as in Examples were formulated at a composition ratio of Comparative Example 2 shown in Table 1, and mixed in a mortar. During calcination at 600° C. for 20 hours in an alumina crucible, the mixture powder was kept at 600° C. for 10 hours, disintegrated in a mortar, and caused to pass through a sieve having an opening diameter of 500 μm, and kept at 600° C. for 10 hours again. The resultant calcined powder was disintegrated in a mortar, and caused to pass through a sieve having an opening diameter of 500 μm to obtain LCBO (x=0.8).

XRD analysis confirmed that this powder had a crystal structure, whose XRD pattern was similar to those of LCBO (x=0.4) plus Li₃BO₃. The peak of a similar pattern to LCBO (x=0.4) was smaller than that of the Li₃BO₃ pattern. This powder was pulverized in toluene as a solvent in a ball mill with zirconia balls, and the resultant slurry was dried, disintegrated in a mortar, and caused to pass through a sieve having an opening diameter of 500 μm to obtain fine particles of LCBO (x=0.8). Using the fine particles of LCBO (x=0.8), a sample was produced by the same method as for the laminates of Examples above, and the resultant sample was evaluated in the same manner as in Examples above.

Table 1 shows the formed phases and ionic conductivities of the sintered body samples of Comparative Examples 1 and 2, and Examples 1-5.

TABLE 1

| | | | | Sintered Body | |
|---|---|---|---|---|---|
| | Sintering Aid | | | | Ionic |
| | | | Crystal | Formed | Conduc- |
| No. | Composition | | Structure | Phases | tivity⁽³⁾ |
| Example 1 | Li_{2.1}C_{0.9}B_{0.1}O₃ | x = | Li₂CO₃ Solid | LLZ⁽¹⁾ | 1 × 10⁻⁷ |
| | | 0.1 | Solution | | |
| Example 2 | Li_{2.2}C_{0.8}B_{0.2}O₃ | x = | Li₂CO₃ Solid | LLZ | 10 × 10⁻⁷ |
| | | 0.2 | Solution | | |
| Example 3 | Li_{2.3}C_{0.7}B_{0.3}O₃ | x = | Li₂CO₃ Solid | LLZ | 1 × 10⁻⁷ |
| | | 0.3 | Solution | | |
| Example 4 | Li_{2.4}C_{0.6}B_{0.4}O₃ | x = | Li₂CO₃ Solid | LLZ | 24 × 10⁻⁷ |
| | | 0.4 | Solution | | |
| Example 5 | Li_{2.6}C_{0.4}B_{0.6}O₃ | x = | Li₂CO₃ Solid | LLZ + | 2 × 10⁻⁷ |
| | | 0.6 | Solution + | LZ⁽²⁾ | |
| | | | Li₃BO₃ | | |
| Com. | Li₃BO₃ | x = 1 | Li₃BO₃ | LZ | 0.5 × 10⁻⁷ |
| Ex. 1 | | | | | |
| Com. | Li_{2.8}C_{0.2}B_{0.8}O₃ | x = | Li₂CO₃ Solid | LZ | 0.8 × 10⁻⁷ |
| Ex. 2 | | 0.8 | Solution + | | |
| | | | Li₃BO₃ | | |

Note:
⁽¹⁾LLZ is Li₇La₃Zr₂O₁₂.
⁽²⁾LZ is La₂Zr₂O₇.
⁽³⁾The unit is S/cm.

FIG. 6 shows the XRD measurement results of Examples 1-5, Comparative Examples 1 and 2, and LLZ powder. Comparative Example 1 has a broad peak assigned to abnormal phases (La₂Zr₂O₇), which is shown by the arrow, at around 47.5°, with no peak peculiar to LLZ seen. Comparative Example 2 also has a peak of abnormal phases (La₂Zr₂O₇), with a small peak of LLZ. Though Examples 1 and 5 have a peak of La₂Zr₂O₇, they have larger peaks of LLZ at around 50.7°, 51.7° and 52.7°, which are shown by the broken lines, than those of Comparative Example 2, indicating that they have LLZ as a main phase, more than La₂Zr₂O₇. Examples 2 and 3 and 4 have clear peaks of LLZ with substantially no peaks of La₂Zr₂O₇, indicating that they have LLZ as a main phase. The above results verify that with the composition of LCBO being 0<x<0.8, the peaks of LLZ are higher than those of abnormal phases, indicating that the formation of abnormal phases by sintering is suppressed. This appears to be due to the fact that the Li₂CO₃ (LCBO) solid solution in the sintering aid mainly suppresses the formation of abnormal phases. The ionic conductivity was 0.5×10⁻⁷ S/cm in Comparative Example 1, but 1×10⁻⁷ S/cm or more in any Examples, indicating the improvement of ionic conductivity. Decrease in low-ionic-conductivity abnormal phases appears to contribute to the improvement of ionic conductivity. It is considered that there were no clear peaks of LCBO in the above XRD data, because most LCBO in the sintered body is amorphous.

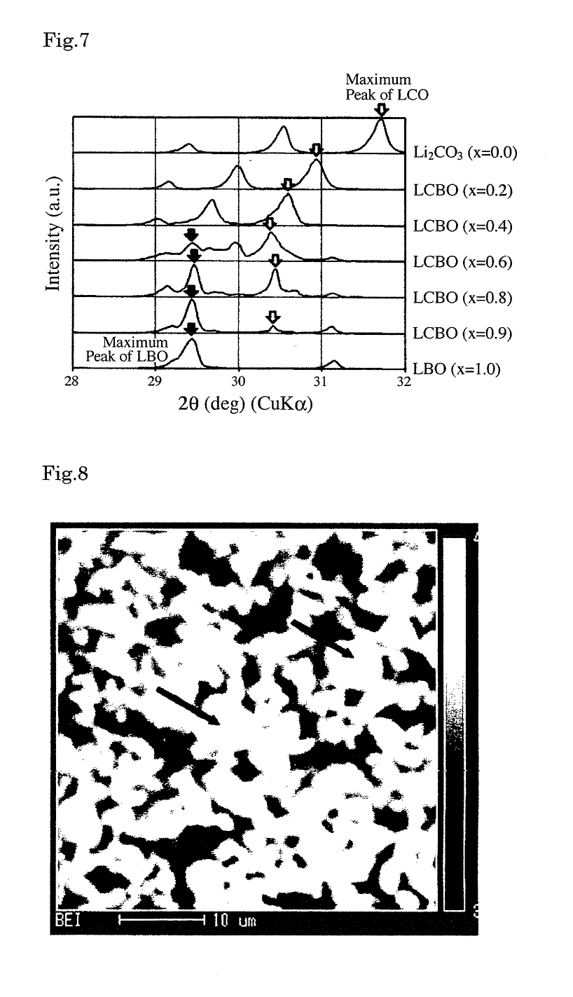

The above Li₂CO₃ solid solution will be explained. FIG. 7 shows the XRD data of compositions formulated with C substituted by B in Li₂CO₃. Because LCBO does not exhibit clear peaks after mixed with LLZ and sintered, the XRD data of LBO are added. The crystal structure changes when the composition ratio x of B changes from 0.6 to 0.8. When the composition ratio x of B is 0.8 or more, the LCBO has a crystal structure of Li₃BO₃, because the maximum peak of Li₃BO₃ (LBO) is larger than that of Li₂CO₃ (LCO). On the other hand, when the composition ratio x of B is less than 0.8, the LCBO is considered to have a crystal structure of Li₂CO₃, because the maximum peak of Li₂CO₃ (LCO) is larger than that of Li₃BO₃ (LBO). When x is more than 0 and 0.6 or less, it is expected that the LCBO has a crystal structure of Li₂CO₃, with changed lattice spacing.

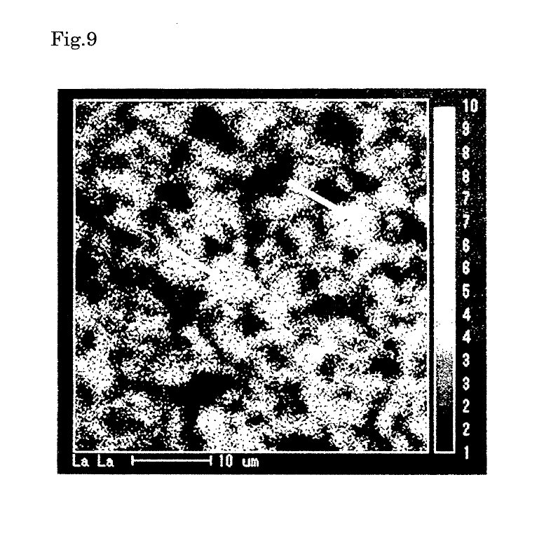

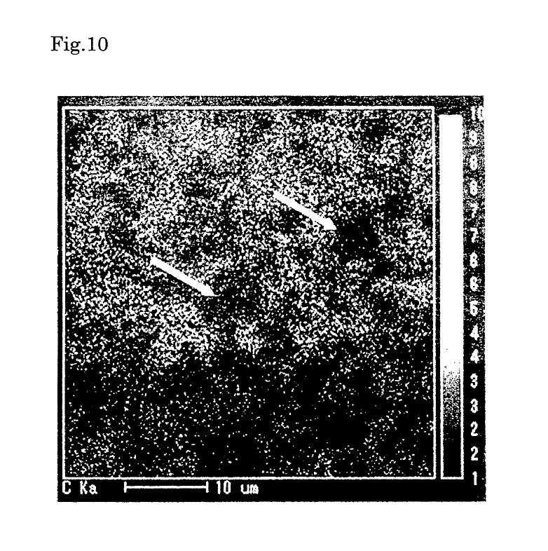

FIG. 8 shows a secondary electron image of a cross section of the sintered body (x=0.4) of Example 4, and FIGS. 9 and 10 show the mapping images of La (lanthanum) and C (carbon), respectively, in the same field as in FIG. 8. The mapping was obtained by EPMA-1610 (Shimadzu Corporation) of wavelength dispersive x-ray spectroscopy (WDX) at acceleration voltage of 15 kV, and current of 30 nA. In the mapping image, each element exists in bright portions. FIG. 9 indicates that La exists in bright portions shown by the arrows in FIG. 8, which are considered to be LLZ particles. The comparison of FIG. 9 with FIG. 10 reveals that C complementarily exists at positions of La. Point analysis indicates that this C-existing portion contains 3% or more by mass of B. Also, LLZ particles contain B in as small an amount as 0.3% by mass. Accordingly, portions containing a large amount of C in FIG. 10 are considered to be LCBO. It is thus concluded that, as shown in the SEM image of FIG. 1, the sintered body of Example 4 has Li-La-Zr garnet phases and Li₂₊ₓC₁₋ₓBₓO₃ (0<x<0.8) phases.

Though only Al was used as an element added to LLZ, and other elements were not added in Examples above, garnet-type solid electrolytes containing other elements also exhibit the same effects.

When the present invention is applied to the production of a solid electrolyte layer by a screen-printing method, too, the formation of abnormal phases by sintering is suppressed, resulting in a solid electrolyte layer having excellent ionic conductivity.

It was confirmed that all-solid-state batteries comprising the solid electrolyte layer thus formed, a positive electrode layer comprising LiCoO₂ and LCBO (Li₂₊ₓC₁₋ₓBₓO₃ (0<x<0.8)) formed under various conditions in Examples, and a negative electrode layer of metal Li were able to conduct charge and discharge.

### EFFECTS OF THE INVENTION

The present invention provides a solid electrolyte with less abnormal phases having low ionic conductivity, and its production method, as well as an all-solid-state lithium-ion secondary battery comprising the above solid electrolyte, a positive electrode, a negative electrode, and a current collector for improved battery characteristics such as charge-discharge characteristics, electric resistance, etc.

### DESCRIPTION OF REFERENCE NUMERALS

1: Solid electrolyte for all-solid-state lithium-ion secondary batteries

2: LLZ crystal grain phase

3: LCBO phase

What is claimed is:

1. A solid electrolyte for all-solid-state lithium-ion secondary batteries, which is a sintered body comprising Li-La-Zr garnet phases and Li₂₊ₓC₁₋ₓBₓO₃ (0<x<0.8) phases.

2. The solid electrolyte for all-solid-state lithium-ion secondary batteries according to claim 1, wherein the range of x is 0.1≤x≤0.6.

3. The solid electrolyte for all-solid-state lithium-ion secondary batteries according to claim 1, wherein said solid electrolyte exhibits an X-ray diffraction pattern having those of Li-La-Zr garnet and a Li₂CO₃ solid solution, and wherein the range of x is 0.2≤x≤0.4.

4. The solid electrolyte for all-solid-state lithium-ion secondary batteries according to claim 1, wherein said Li-La-Zr garnet is a compound having a garnet-type crystal structure, which is Li₇La₃Zr₂O₁₂, or Li₇La₃Zr₂O₁₂ partially substituted by at least one element selected from the group consisting of Nb, Al and Ta.

5. An all-solid-state lithium-ion secondary battery comprising the solid electrolyte recited in claim 1, a positive electrode, and a negative electrode.

6. The all-solid-state lithium-ion secondary battery according to claim 5, wherein said positive electrode is made of LiCoO₂ and Li₂₊ₓC₁₋ₓBₓO₃ (0<x<0.8).

7. A method for producing a solid electrolyte for all-solid-state lithium-ion secondary batteries, comprising the steps of mixing raw materials comprising Li-La-Zr garnet and Li₂₊ₓC₁₋ₓBₓO₃ (0<x<0.8), molding the mixed raw materials, and sintering the resultant green body.

8. The method for producing a solid electrolyte for all-solid-state lithium-ion secondary batteries according to claim 7, wherein lithium carbonate and a boron compound are mixed at a predetermined ratio, and calcined to form Li₂₊ₓC₁₋ₓBₓO₃ (0<x<0.8).

9. The method for producing a solid electrolyte for all-solid-state lithium-ion secondary batteries according to claim 8, wherein said boron compound is boric acid or boron oxide.

10. The method for producing a solid electrolyte for all-solid-state lithium-ion secondary batteries according to claim 7, wherein the raw material comprising Li₂₊ₓC₁₋ₓBₓO₃ (0<x<0.8) has diameters of less than 10 μm.

11. The method for producing a solid electrolyte for all-solid-state lithium-ion secondary batteries according to claim 7, wherein said raw materials are mixed with a solvent to prepare a slurry, which is formed into sheets.
